(19) United States
(12) Patent Application Publication
(10) Pub. No.: US 2023/0262831 A1
(43) Pub. Date: Aug. 17, 2023

(54) COMMUNICATION CONTROL METHOD

(71) Applicant: KYOCERA CORPORATION, Kyoto (JP)

(72) Inventors: Masato FUJISHIRO, Yokohama-shi (JP); Henry CHANG, San Diego, CA (US)

(73) Assignee: KYOCERA CORPORATION, Kyoto (JP)

(21) Appl. No.: 18/303,622

(22) Filed: Apr. 20, 2023

Related U.S. Application Data
(63) Continuation of application No. PCT/JP2021/038489, filed on Oct. 18, 2021.
(60) Provisional application No. 63/093,918, filed on Oct. 20, 2020.

(51) Int. Cl. H04W 76/27; H04W 74/08; H04L 12/18; H04W 76/10

(52) U.S. Cl. CPC H04W 76/27; H04L 12/1845; H04W 74/0833; H04W 76/10

(57) ABSTRACT

A communication control method used in a mobile communication system for providing a multicast and broadcast service (MBS) from a first base station to a first user equipment includes collecting, by the first base station and from at least one second base station within a predetermined range from the first base station, MBS interest information received by the at least one second base station from a second user equipment, and controlling, by the first base station, MBS transmission of the first base station, based on the MBS interest information collected.

### RELATED APPLICATIONS

The present application is a continuation based on PCT Application No. PCT/JP2021/038489, filed on Oct. 18, 2021, which claims the benefit of U.S. Provisional Application No. 63/093,918 filed on Oct. 20, 2020. The content of which is incorporated by reference herein in their entirety.

### TECHNICAL FIELD

The present invention relates to a communication control method used in a mobile communication system.

### BACKGROUND OF INVENTION

In recent years, a mobile communication system of the fifth generation (5G) has attracted attention. New Radio (NR), which is a Radio Access Technology (RAT) of the 5G system, has features such as high speed, large capacity, high reliability, and low latency compared to Long Term Evolution (LTE), which is a fourth generation radio access technology.

### CITATION LIST

### Non-Patent Literature

Non-Patent Document 1: 3GPP Technical Specification “3GPP TS 38.300 V16.3.0 (2020-09)”

### SUMMARY

In a first aspect, a communication control method is a communication control method used in a mobile communication system for providing a multicast and broadcast service (MBS) from a first base station to a first user equipment and includes collecting, by the first base station and from at least one second base station within a predetermined range from the first base station, MBS interest information received by the at least one second base station from a second user equipment, and controlling, by the first base station, MBS transmission of the first base station, based on the MBS interest information collected.

In a second aspect, a communication control method is a communication control method used in a mobile communication system for providing a multicast and broadcast service (MBS) from a base station to a user equipment and includes notifying, by the user equipment in a Radio Resource Control (RRC) idle state or an RRC inactive state, a base station of MBS interest information at time of a random access procedure to the base station, and after notification of the MBS interest information, terminating, by the user equipment, the random access procedure without the user equipment transitioning to an RRC connected state.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a base station (gNB) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signalling (control signal).

FIG. 6 is a diagram illustrating a correspondence relationship between a downlink Logical channel and a downlink Transport channel according to an embodiment.

FIG. 7 is a diagram illustrating a delivery method of MBS data according to an embodiment.

FIG. 8 is a diagram illustrating an operating environment according to an embodiment.

FIG. 9 is a diagram illustrating an example of operation pattern 1 of collecting operation of MBS interest information according to an embodiment.

FIG. 10 is a diagram illustrating an example of operation pattern 2 of collecting operation of MBS interest information according to an embodiment.

FIG. 11 is a diagram illustrating an operation example of MBS counting according to an embodiment.

FIG. 12 is a diagram illustrating a two-stage configuration in LTE SC-PTM.

FIG. 13 is a diagram illustrating a configuration diagram capable of NR MBS.

### DESCRIPTION OF EMBODIMENTS

Introduction of multicast and broadcast services to the 5G system (NR) has been under study. NR multicast and broadcast services are desired to provide enhanced services compared to LTE multicast and broadcast services.

In view of this, the present invention provides a communication control method for implementing enhanced multicast and broadcast services.

A mobile communication system according to an embodiment will be described with reference to the drawings. In the description of the drawings, the same or similar parts are denoted by the same or similar reference signs.

### Configuration of Mobile Communication System

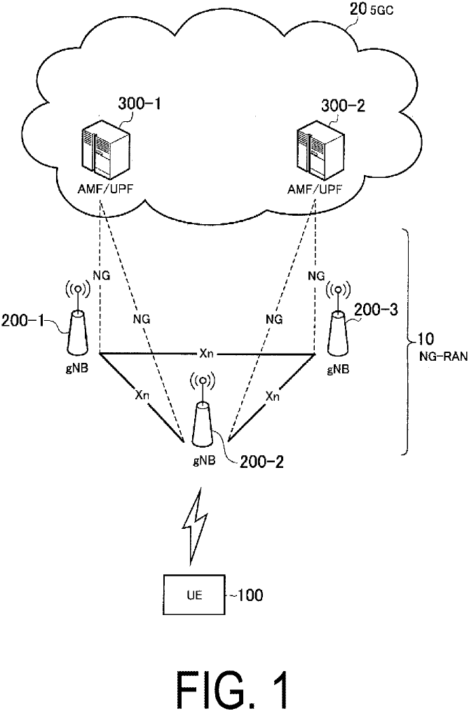

First, a configuration of a mobile communication system according to an embodiment will be described. FIG. 1 is a diagram illustrating a configuration of the mobile communication system according to an embodiment. This mobile communication system complies with the 5th Generation System (5GS) of the 3GPP standard. The description below takes the 5GS as an example, but a Long Term Evolution (LTE) system may be at least partially applied to the mobile communication system, or a sixth generation (6G) system may be at least partially applied thereto.

As illustrated in FIG. 1, the mobile communication system includes a User Equipment (UE) 100, a 5G radio access network (Next Generation Radio Access Network (NG-RAN)) 10, and a 5G Core Network (5GC) 20.

The UE 100 is a mobile wireless communication apparatus. The UE 100 may be any apparatus as long as utilized by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), or a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or a plurality of cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of wireless communication area. The “cell” is also used as a term representing a function or a resource for performing wireless communication with the UE 100. One cell belongs to one carrier frequency.

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signalling. The UPF controls data transfer. The AMF and UPF are connected to the gNB 200 via an NG interface which is an interface between a base station and the core network.

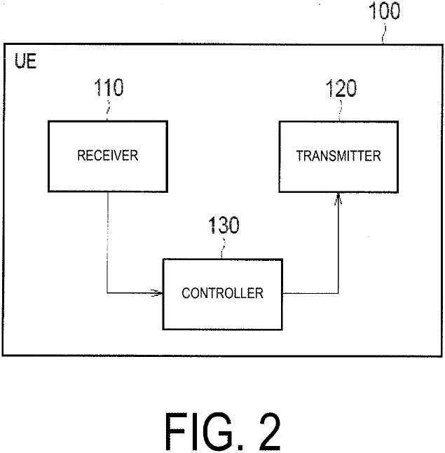

FIG. 2 is a diagram illustrating a configuration of the UE 100 (user equipment) according to an embodiment.

As illustrated in FIG. 2, the UE 100 includes a receiver 110, a transmitter 120, and a controller 130.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal output by the controller 130 (a transmission signal) into a radio signal and transmits the resulting signal through the antenna.

The controller 130 performs various types of control in the UE 100. The controller 130 includes at least one processor and at least one memory. The memory stores a program to be executed by the processor and information to be used for processing by the processor. The processor may include a baseband processor and a central processing unit (CPU). The baseband processor performs modulation and demodulation, coding and decoding, and the like of a baseband signal. The CPU executes the program stored in the memory to thereby perform various types of processing.

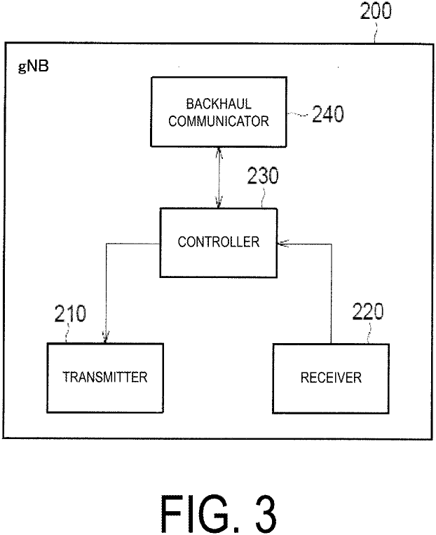

FIG. 3 is a diagram illustrating a configuration of the gNB 200 (base station) according to an embodiment.

As illustrated in FIG. 3, the gNB 200 includes a transmitter 210, a receiver 220, a controller 230, and a backhaul communicator 240.

The transmitter 210 performs various types of transmission under control of the controller 230. The transmitter 210 includes an antenna and a transmission device. The transmission device converts a baseband signal output by the controller 230 (a transmission signal) into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of controls for the gNB 200. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via the inter-base station interface. The backhaul communicator 240 is connected to the AMF/UPF 300 via the interface between a base station and the core network. Note that the gNB may include a Central Unit (CU) and a Distributed Unit (DU) (i.e., functions are divided), and both units may be connected via an F1 interface.

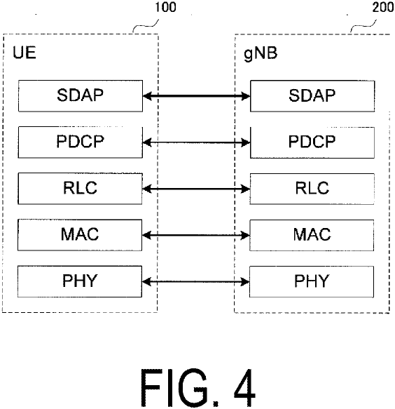

FIG. 4 is a diagram illustrating a configuration of a protocol stack of a radio interface of a user plane handling data.

As illustrated in FIG. 4, a radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel.

The MAC layer performs preferential control of data, retransmission processing using a hybrid ARQ (HARQ), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, modulation and coding schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression and decompression, and encryption and decryption.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP may not be provided.

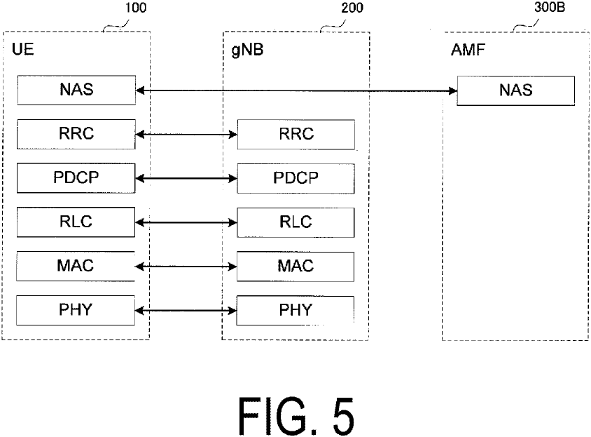

FIG. 5 is a diagram illustrating a configuration of a protocol stack of a radio interface of a control plane handling signalling (control signal).

As illustrated in FIG. 5, the protocol stack of the radio interface of the control plane includes a Radio Resource Control (RRC) layer and a Non-Access Stratum (NAS) layer instead of the SDAP layer illustrated in FIG. 4.

RRC signalling for various configurations is transmitted between the RRC layer of the UE 100 and the RRC layer of the gNB 200. The RRC layer controls a logical channel, a transport channel, and a physical channel according to establishment, reestablishment, and release of a radio bearer. When a connection between the RRC of the UE 100 and the RRC of the gNB 200 (RRC connection) exists, the UE 100 is in an RRC connected state. When a connection between the RRC of the UE 100 and the RRC of the gNB 200 (RRC connection) does not exist, the UE 100 is in an RRC idle state. When the connection between the RRC of the UE 100 and the RRC of the gNB 200 is suspended, the UE 100 is in an RRC inactive state.

The NAS layer which is higher than the RRC layer performs session management, mobility management, and the like. NAS signalling is transmitted between the NAS layer of the UE 100 and the NAS layer of an AMF 300B.

Note that the UE 100 includes an application layer other than the protocol of the radio interface.

### MBS

An MBS according to an embodiment will be described. The MBS is a service in which the NG-RAN 10 provides broadcast or multicast, that is, Point To Multipoint (PTM) data transmission to the UE 100. The MBS may be referred to as the Multimedia Broadcast and Multicast Service (MBMS). Note that use cases (service types) of the MBS include public communication, mission critical communication, V2X (Vehicle to Everything) communication, IPv4 or IPv6 multicast delivery, IPTV, group communication, and software delivery.

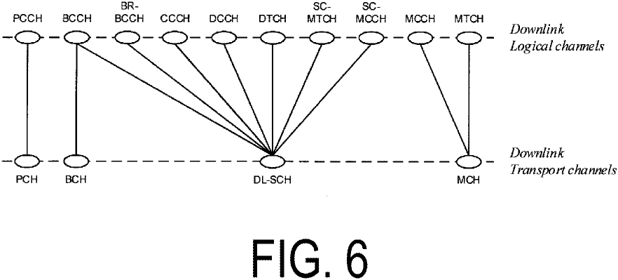

MBS Transmission in LTE includes two schemes, i.e., a Multicast Broadcast Single Frequency Network (MBSFN) transmission and Single Cell Point To Multipoint (SC-PTM) transmission. FIG. 6 is a diagram illustrating a correspondence relationship between a downlink Logical channel and a downlink Transport channel according to an embodiment.

As illustrated in FIG. 6, the logical channels used for MBSFN transmission are a Multicast Traffic Channel (MTCH) and a Multicast Control Channel (MCCH), and the transport channel used for MBSFN transmission is a Multicast Channel (MCH). The MBSFN transmission is designed primarily for multi-cell transmission, and in an MBSFN area including a plurality of cells, each cell synchronously transmits the same signal (the same data) in the same MBSFN subframe.

The logical channels used for SC-PTM transmission are a Single Cell Multicast Traffic Channel (SC-MTCH) and a Single Cell Multicast Control Channel (SC-MCCH), and the transport channel used for SC-PTM transmission is a Downlink Shared Channel (DL-SCH). The SC-PTM transmission is primarily designed for single-cell transmission, and corresponds to broadcast or multicast data transmission on a cell-by-cell basis. The physical channels used for SC-PTM transmission are a Physical Downlink Control Channel (PDCCH) and a Physical Downlink Shared Channel (PDSCH), and enables dynamic resource allocation.

Although an example will be mainly described below in which the MBS is provided using the SC-PTM transmission scheme, the MBS may be provided using the MBSFN transmission scheme. An example will be mainly described in which the MBS is provided using multicast. Accordingly, the MBS may be interpreted as multicast. Note that, the MBS may be provided using broadcast.

MBS data refers to data transmitted using the MBS, an MBS control channel refers to the MCCH or SC-MCCH, and an MBS traffic channel refers to the MTCH or SC-MTCH. Note that the MBS data may be transmitted using unicast. The MBS data may be referred to as an MBS packet or MBS traffic.

The network can provide different MBS services for respective MBS sessions. The MBS session is identified by at least one selected from the group consisting of a Temporary Mobile Group Identity (TMGI) and a session identifier, and at least one of these identifiers is referred to as an MBS session identifier. Such an MBS session identifier may be referred to as an MBS service identifier or a multicast group identifier.

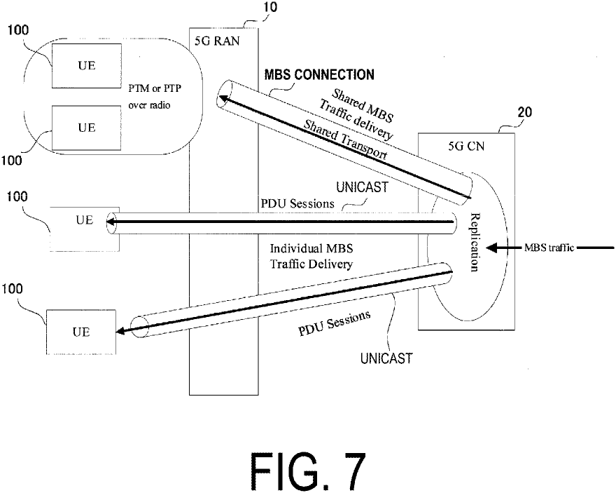

FIG. 7 is a diagram illustrating a delivery method of the MBS data according to an embodiment.

As illustrated in FIG. 7, the MBS data (MBS Traffic) is delivered to a plurality of UEs from a single data source (application service provider). The 5G CN (5GC) 20 being a 5G core network receives the MBS data from the application service provider, creates a copy (performs Replication) of the MBS data, and delivers the MBS data.

From the point of view of the 5GC 20, two delivery methods, i.e., shared MBS data delivery (Shared MBS Traffic delivery) and individual MBS data delivery (Individual MBS Traffic delivery), are possible.

In the shared MBS data delivery, connection is established between the NG-RAN 10 being a 5G radio access network (5G RAN) and the 5GC 20, and the MBS data is delivered from the 5GC 20 to the NG-RAN 10. In the following description, such connection (tunnel) is referred to as “MBS connection”.

The MBS connection may be referred to as Shared MBS Traffic delivery connection or shared transport. The MBS connection is terminated in the NG-RAN 10 (that is, the gNB 200). The MBS connection may correspond to the MBS session on a one-to-one basis. The gNB 200 selects one of Point-to-Point (PTP: unicast) and Point-to-Multipoint (PTM: multicast or broadcast) by its own determination, and transmits the MBS data to the UE 100 using the selected method.

In contrast, in the individual MBS data delivery, a unicast session is established between the NG-RAN 10 and the UE 100, and the MBS data is individually delivered from the 5GC 20 to the UE 100. Such unicast may be referred to as a PDU session. The unicast (PDU session) is terminated in the UE 100.

### MBS Interest Information

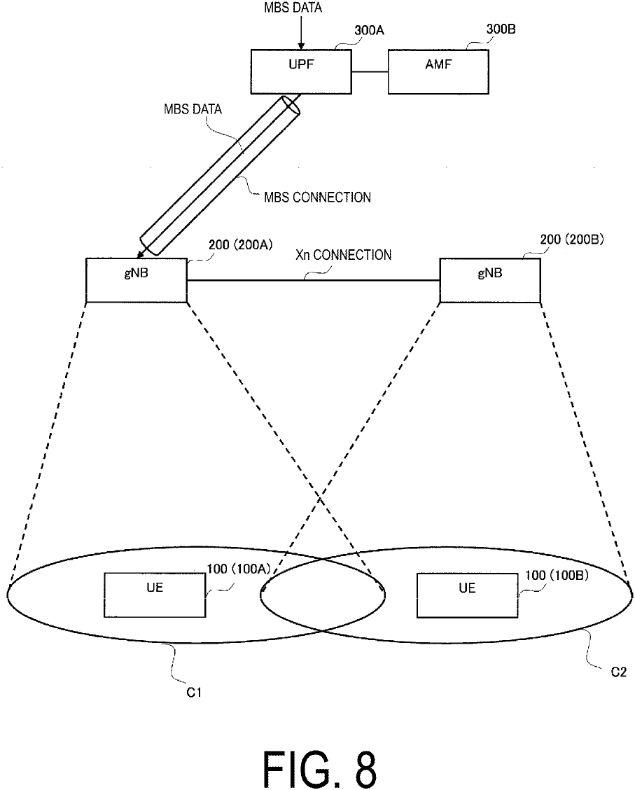

MBS interest information according to an embodiment will be described. FIG. 8 is a diagram illustrating an operating environment according to an embodiment.

As illustrated in FIG. 8, a gNB 200A manages a cell C1, and a gNB 200B manages a cell C2. In the cell C1, a UE 100A is present, and in the cell C2, a UE 100B is present. The UE 100A may move from the cell C1 to the cell C2. In the same manner and/or a similar manner, the UE 100B may move from the cell C2 to the cell C1.

Note that, although an example in which the cell sizes of the cell C1 and the cell C2 are equal is illustrated, the cell sizes of the cell C1 and the cell C2 may be different from each other. Geographical regions of the cell C1 and the cell C2 at least partially overlap. Such a relationship between the cells may be referred to as neighboring cells. The UE 100A and the UE 100B may be present in a region in which these cells overlap.

The gNB 200A and the gNB 200B communicate with each other via an Xn interface (Xn connection) being an inter-base station interface. Note that communication between the gNB 200A and the gNB 200B is not limited to being performed via the Xn interface, and communication between the gNB 200A and the gNB 200B may be performed via an NG interface being an interface between the base station and the core network and a core network apparatus. In the following description, an example in which communication between the gNB 200A and the gNB 200B is performed via the Xn interface will be mainly described.

Under such an environment, the cell C1 and the cell C2 may belong to the same MBS area. The MBS area refers to an area including a plurality of cells, in which the same MBS session is provided. The plurality of cells belonging to the same MBS area may provide the MBS session with the same frequency, and configure a Single Frequency Network (SFN). The gNB 200A may operate as a master that manages or controls MBS transmission in the MBS area.

In an embodiment, the gNB 200A performs at least one of the following MBS transmission controls 1 to 3, based on whether the respective UEs 100 present in the cell C1 being its own cell and the cell C2 being a neighboring cell are interested in MBS reception.

### MBS Transmission Control 1

The gNB 200A determines whether to establish MBS connection with the core network apparatus (UPF 300A). In order that the gNB 200A transmits the MBS data using PTM, the gNB 200A needs to have MBS connection, that is, shared MBS data delivery (Shared MBS Traffic delivery) connection. For example, when a large number of UEs 100 interested in MBS reception of a certain MBS session are present, the gNB 200A establishes MBS connection to transmit the MBS data of the MBS session using PTM. In contrast, when a small number of or no UEs 100 interested in MBS reception of a certain MBS session are present, the gNB 200A does not establish MBS connection.

Note that establishment and release of MBS connection are controlled by the AMF 300B. The AMF 300B is another example of the core network apparatus. Note that, instead of the AMF 300B, a Session Management Function (SMF) may control establishment and release of MBS connection. The SMF is another example of the core network apparatus.

### MBS Transmission Control 2

The gNB 200A having MBS connection with the core network (UPF 300A) determines which is to be used among PTP and PTM to transmit the MBS data received from the core network apparatus (UPF 300A) via MBS connection. For example, when a large number of UEs 100 interested in MBS reception of a certain MBS session are present, the gNB 200A transmits the MBS data of the MBS session by using PTM. In contrast, when a small number of UEs 100 interested in MBS reception of a certain MBS session are present, the gNB 200A transmits the MBS data of the MBS session by using PTP.

### MBS Transmission Control 3

The gNB 200A determines whether to constitute the SFN with its own cell and another cell. For example, when a large number of UEs 100 interested in MBS reception of a certain MBS session are present, the gNB 200A transmits the MBS data of the MBS session by using the MBSFN. In contrast, when a small number of UEs 100 interested in MBS reception of a certain MBS session are present, the gNB 200A does not transmit the MBS data of the MBS session using the MBSFN.

In order to perform at least one of MBS transmission controls 1 to 3 as described above, the gNB 200A collects the MBS interest information that the gNB 200B received from the UE 100B, from at least one gNB 200B within a predetermined range from the gNB 200A. The gNB 200B within the predetermined range refers to the gNB 200B with a neighboring relationship, or the gNB 200B belonging to the same MBS area as the gNB 200A. The gNB 200A performs at least one of MBS transmission controls 1 to 3, based on the collected MBS interest information.

In operation pattern 1 of collecting the MBS interest information, the gNB 200B receives the MBS interest information from the UE 100B. The MBS interest information may be an MBS interest information message voluntarily transmitted by the UE 100B or an information element included in the message, or may be an MBS counting response message transmitted by the UE 100B in response to a request from the gNB 200B or an information element included in the message.

Such a message (MBS interest information) may be an RRC message, for example, and may include an identifier related to the MBS session of which the UE 100B is interested in MBS reception (or during MBS reception). The identifier related to the MBS session may be a message including at least one of an identifier indicating the MBS session (for example, a TMGI, a session ID) and/or a group Radio Network Temporary Identifier (RNTI), an identifier of a QoS flow corresponding to the MBS session, and an identifier of a frequency in which the MBS session is provided.

The gNB 200A transmits a transmission request for the MBS interest information to the gNB 200B. For example, the gNB 200A transmits the transmission request for the MBS interest information to the gNB 200B on the Xn interface.

The gNB 200B transmits the MBS interest information received from the UE 100B to the gNB 200A, in response to reception of the transmission request from the gNB 200A. For example, the gNB 200B transmits the MBS interest information to the gNB 200A on the Xn interface. Thus, the gNB 200B can recognize the MBS interest of the UE 100B of a neighboring cell.

The message including the MBS interest information transmitted from the gNB 200B to the gNB 200A may include at least one of an identifier of the UE 100B (for example, an XnAP ID being a UE identifier used on the Xn interface), an identifier of the gNB 200B, and an identifier of the cell C2.

The gNB 200B may receive the MBS interest information from a plurality of UEs 100B, and transmit aggregate results of the received MBS interest information to the gNB 200A. The aggregate results may be an aggregated number (total value) for each list of identifiers included in the message (MBS interest information) from the UE 100B and/or for each of the identifiers.

Note that the gNB 200B may voluntarily transmit the MBS interest information received from the UE 100B to the gNB 200A even when the gNB 200B does not receive the transmission request from the gNB 200A. For example, when the gNB 200B receives the MBS interest information from the UE 100B, the gNB 200B may transmit the received MBS interest information to the gNB 200A.

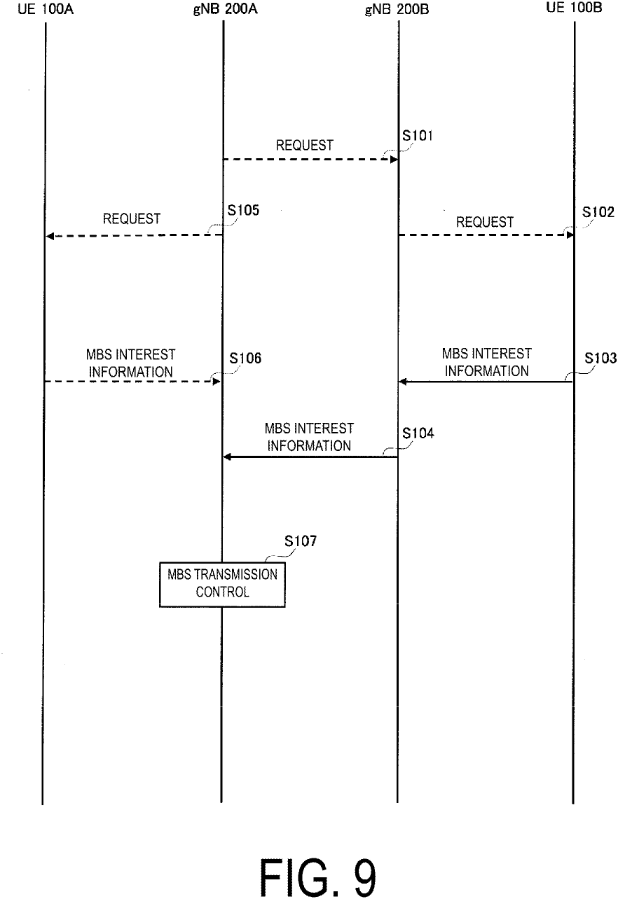

FIG. 9 is a diagram illustrating an example of operation pattern 1 of collecting operation of the MBS interest information. In FIG. 9, optional steps are illustrated with broken lines.

As illustrated in FIG. 9, in Step S101, the gNB 200A transmits the transmission request for the MBS interest information to the gNB 200B. Such a transmission request may be an Xn message, for example, and may include at least one of an identifier related to the MBS session as a collection target of the MBS interest, transmission periodicity (report periodicity) of the MBS interest information from the gNB 200B, and an identifier of a cell as a collection target of the MBS interest.

In Step S102, the gNB 200B transmits the transmission request for the MBS interest information to the UE 100B. Such a transmission request may be an RRC message, for example, and may include an identifier related to the MBS session as a collection target of the MBS interest (specific examples are the same as and/or similar to the above). The transmission request may be transmitted to the UE 100B by unicast, or may be transmitted to the UE 100B by multicast or broadcast.

In Step S103, the UE 100B transmits the MBS interest information related to the MBS interest of the UE 100B to the gNB 200B.

In Step S104, the gNB 200B transmits the MBS interest information received from the UE 100B to the gNB 200A.

Meanwhile, in Step S105, the gNB 200A transmits the transmission request for the MBS interest information to the UE 100A.

In Step S106, the UE 100A transmits the MBS interest information related to the MBS interest of the UE 100A to the gNB 200A. The gNB 200A may receive the MBS interest information from each of the plurality of UEs 100A, and transmit the received MBS interest information or aggregate results thereof to the gNB 200A.

In Step S107, the gNB 200A performs at least one of MBS transmission controls 1 to 3 described above, based on the MBS interest information received from the gNB 200B (and the MBS interest information received from the UE 100A). The gNB 200A may aggregate the MBS interest information received from the gNB 200B (and the MBS interest information received from the UE 100A), and report the aggregate results to the gNB 200B or another gNB.

Next, operation pattern 2 of collecting the MBS interest information will be described.

When the UE 100B during MBS reception (or the UE 100B interested in MBS reception) in the cell C2 is in the RRC idle state or the RRC inactive state, the UE 100B may move from the cell C2 to the cell C1, of which the gNB 200B is unaware. Here, a problem may occur that the MBS session in which the UE 100B is interested is not provided in the cell C1.

In operation pattern 2, when the gNB 200B receives the MBS interest information from the UE 100B in the RRC connected state and then transitions the UE 100 to the RRC idle state or the RRC inactive state, the gNB 200B transmits the MBS interest information that the gNB 200B has received from the UE 100B to the gNB 200A. Thus, the gNB 200A can prepare MBS transmission in advance for the UE 100B that may move to its own cell C1.

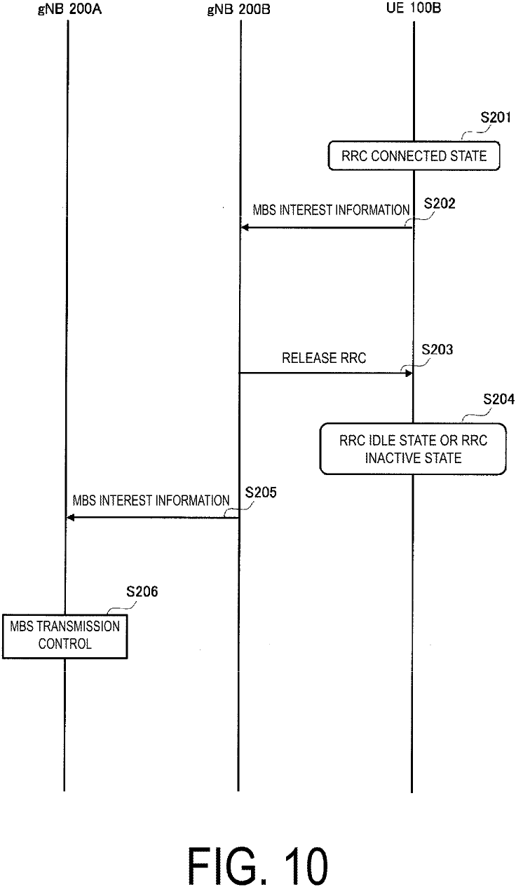

FIG. 10 is a diagram illustrating an example of operation pattern 2 of collecting operation of the MBS interest information. Operation pattern 2 can be used together with operation pattern 1. Here, operation pattern 2 will be described mainly on its differences from operation pattern 1.

As illustrated in FIG. 10, in Step S201, the UE 100B is in the RRC connected state.

In Step S202, the UE 100B transmits the MBS interest information to the gNB 200B.

In Step S203, the gNB 200B transmits, to the UE 100B, an RRC release message for transitioning the UE 100B to the RRC idle state or the RRC inactive state.

In Step S204, the UE 100B transitions to the RRC idle state or the RRC inactive state.

In Step S205, the gNB 200 transmits the MBS interest information to the gNB 200A.

In Step S206, the gNB 200A performs at least one of MBS transmission controls 1 to 3 described above, based on the MBS interest information received from the gNB 200B (and the MBS interest information received from the UE 100A).

### MBS Counting

MBS counting according to an embodiment will be described. MBS counting according to an embodiment may be used together with operation pattern 1 or 2 described above, or may be performed separately from operation pattern 1 or 2 described above.

In general, in order that the UE 100 transmits the MBS interest information to the gNB 200, the UE 100 needs to be in the RRC connected state. However, it is inefficient that the UE 100 in the RRC idle state or the RRC inactive state transitions to the RRC connected state in order to only transmit the MBS interest information.

Thus, the UE 100 in the RRC idle state or the RRC inactive state notifies the gNB 200 of the MBS interest information at the time of random access procedure to the gNB 200. After performing notification of the MBS interest information, the UE 100 terminates the random access procedure without transitioning to the RRC connected state. Thus, the UE 100 in the RRC idle state or the RRC inactive state can notify the gNB 200 of the MBS interest information while remaining in the RRC idle state or the RRC inactive state.

In an embodiment, the UE 100 in the RRC idle state or the RRC inactive state may receive, from the gNB 200, a request message for requesting transmission of the MBS interest information. In response to reception of the request message, the UE 100 may notify the gNB 200 of the MBS interest information at the time of the random access procedure to the gNB 200.

The random access procedure includes preamble transmission of transmitting a random access preamble from the UE 100 to the gNB 200. The UE 100 may notify the gNB 200 of the MBS interest information through preamble transmission.

The random access procedure includes predetermined message transmission of transmitting a predetermined message from the UE 100 to the gNB 200 in response to that the UE 100 has received a random access response from the gNB 200. The UE 100 may notify the gNB 200 of the MBS interest information through predetermined message transmission. In this case, the UE 100 may notify the gNB 200 through preamble transmission that the UE 100 is to perform notification of the MBS interest information through predetermined message transmission.

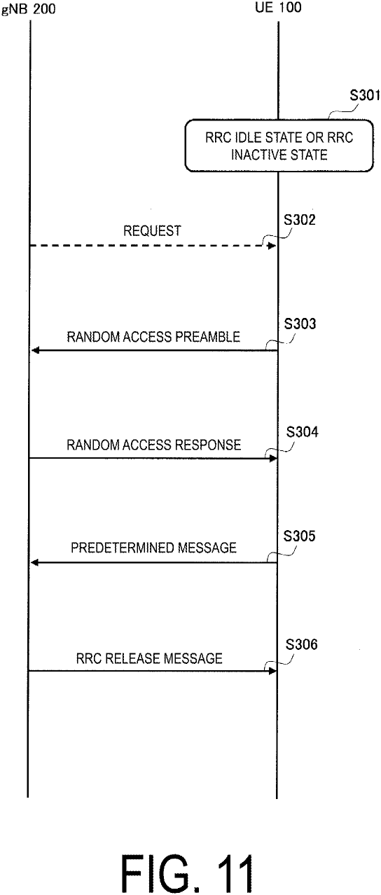

FIG. 11 is a diagram illustrating an operation example of MBS counting according to an embodiment. In FIG. 11, optional steps are illustrated with broken lines.

As illustrated in FIG. 11, in Step S301, the UE 100 is in the RRC idle state or the RRC inactive state. It is assumed that no user data to be transmitted from the UE 100 to the gNB 200 is generated.

In Step S302, the gNB 200 transmits a request message for requesting transmission of the MBS interest information. The gNB 200 may transmit the request message by broadcast via an MBS control channel or a broadcast control channel. The UE 100 receives the request message. The request message may include at least one of an identifier related to the MBS session as a collection target of the MBS interest (specific examples are the same as and/or similar to the above) and a transmission configuration of the random access preamble. The transmission configuration of the random access preamble includes information related to specific Physical Random Access Channel (PRACH) resources to be described later.

In Step S303, the UE 100 initiates the random access procedure and transmits the random access preamble to the gNB 200.

For such preamble transmission, the following preamble transmission method 1 or 2 may be used.

### Preamble Transmission Method 1

The UE 100 may transmit the random access preamble on specific PRACH resources prepared for notifying the gNB 200 of an intention of the UE 100 in the RRC idle state or the RRC inactive state to transmit the MBS interest information. The PRACH resources refer to at least one of time and frequency resources and a preamble sequence. The gNB 200 receives the random access preamble on the specific PRACH resources, and thereby considers the intention of the UE 100 and allocates an appropriate amount of uplink radio resources in Step S304 to be described later.

### Preamble Transmission Method 2

The UE 100 may transmit the random access preamble on specific PRACH resources associated with the MBS session (for example, the TMGI) that the UE 100 is receiving or that the UE 100 is interested in receiving. Thus, the gNB 200 can recognize presence of the UE 100 that is receiving a specific MBS session or that is interested in receiving the specific MBS session. Note that, when a plurality of UEs 100 simultaneously use the specific PRACH resources, it is difficult for the gNB 200 to recognize the number of UEs 100 that are receiving the specific MBS session or that are interested in receiving the specific MBS session. Thus, in Step S305 to be described later, it is assumed that the UE 100 transmits an indication (for example, a flag of 1 bit) indicating that the preamble transmission has been performed. Thus, the gNB 200 can recognize the number of UEs 100 that are receiving the specific MBS session or that are interested in receiving the specific MBS session.

In Step S304, the gNB 200 transmits a random access response to the UE 100 in response to reception of the random access preamble. The random access response includes an uplink grant for allocating uplink radio resources (PUSCH resources) to the UE 100.

In Step S305, in response to reception of the random access response, the UE 100 transmits, to the gNB 200, a predetermined message by using the uplink radio resources allocated from the gNB 200. The predetermined message may be referred to as message 3 (Msg3).

For such predetermined message transmission, one of the following message transmission methods 1 to 3 may be used.

### Message Transmission Method 1

The UE 100 transmits the MBS interest information to the gNB 200 together with an RRC Setup message or an RRC Resume Request message. The RRC Setup message is an RRC connection request message transmitted by the UE 100 in the RRC idle state. The RRC Resume Request message is an RRC connection recovery request message transmitted by the UE 100 in the RRC inactive state. The UE 100 may include the MBS interest information in the RRC Setup message or the RRC Resume Request message, or may multiplex the MBS interest information on the same transport block as the RRC Setup message or the RRC Resume Request message to transmit the MBS interest information.

### Message Transmission Method 2

When preamble transmission method 2 described above is used, the UE 100 includes the above-described indication in the RRC Setup message or the RRC Resume Request message to transmit the indication.

### Message Transmission Method 3

The UE 100 transmits only a message of the MBS interest information to the gNB 200. In this case, the UE 100 does not transmit the RRC Setup message or the RRC Resume Request message.

In message transmission methods 1 to 3, the UE 100 may include an identifier (for example, a 5G-S-TMSI or an IMSI) of the UE 100 in the MBS interest information (predetermined message). The UE 100 may store an identifier indicating that it is message transmission for transmitting the MBS interest information in a Cause field included in the RRC Setup message or the RRC Resume Request message. Thus, the gNB 200 can determine to release the UE 100 in Step S306 to be described later.

In Step S306, the gNB 200 transmits, to the UE 100, a message (for example, an RRC release message) for causing the UE 100 to remain in the RRC idle state or the RRC inactive state. Thus, the UE 100 terminates the random access procedure without transitioning to the RRC connected state.

Note that, in the present operation example, the UE 100 is permitted to transmit the MBS interest information only once for a single request message (Step S302). This is because if one UE 100 transmits the MBS interest information multiple times, an error may be caused in the aggregate results (counting results).

### Other Embodiments

In the embodiments described above, an example in which the base station is an NR base station (gNB) is described; however, the base station may be an LTE base station (eNB). The base station may be a relay node such as an Integrated Access and Backhaul (IAB) node. The base station may be a Distributed Unit (DU) of the IAB node.

In the embodiments described above, communication between the base stations is mainly assumed; however, communication within the base station may be assumed. For example, the base station may be separated into the CU and the DU, and communication may be performed between the CU and the DU. In this case, the Xn interface described above may be replaced with an F1 interface being an interface between the CU and the DU, and various messages and pieces of information described above may be transmitted and received via the F1 interface. Each of the gNB 200A and the gNB 200B described above may be interpreted as the CU and/or the DU.

In addition, the CU may be separated into a CU-CP and a CU-UP, and communication may be performed between the CU-CP and the CU-UP. In this case, the Xn interface described above may be replaced with an E1 interface being an interface between the CU-CP and the CU-UP, and various messages and pieces of information described above may be transmitted and received via the E1 interface. Each of the gNB 200A and the gNB 200B described above may be interpreted as the CU-CP and/or the CU-UP.

A program causing a computer to execute each of the processes performed by the UE 100 or the gNB 200 may be provided. The program may be recorded on a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing the processes to be performed by the UE 100 or the gNB 200 may be integrated, and at least part of the UE 100 or the gNB 200 may be configured as a semiconductor integrated circuit (a chipset or a system on a chip (SoC)).

Embodiments have been described above in detail with reference to the drawings, but specific configurations are not limited to those described above, and various design variation can be made without departing from the gist of the present disclosure.

### Supplementary Note

### Introduction

Revised work items have been approved that are related to NR multicast and broadcast services (MBS). The purposes of the work items are as follows.
Define broadcast/multicast RAN basic functions of the UE in the RRC connected state.
   Define a group scheduling mechanism that allows the UE to receive broadcast/multicast services.
   The purpose includes defining an extended function required to allow simultaneous operation with unicast reception.
   Define support for dynamic change of broadcast/multicast service delivery between multicast (PTM) and unicast (PTP) with predefined UE service continuity.
   Define support for basic mobility with service continuity.
   On the assumption that the gNB-CU includes required adjustment functions (such as functions hosted by MCE), define changes required for RAN architectures and interfaces in consideration of the results of the SA2 SI in broadcast/multicast.
   Define changes required to improve the reliability of broadcast/multicast services, for example, by UL feedback. The level of reliability should be based on the requirements of the application/service provided.
   Study support for the dynamic control of the broadcast/multicast transmission area in one gNB-DU and define what is required to enable the support, if any.
Define broadcast/multicast RAN basic functions of the UE in the RRC idle/RRC inactive state.
Define changes required to enable the UE in the RRC idle/RRC inactive state to receive Point to Multipoint transmission in order to maximize commonalities maintained between the RRC connected state and the RRC idle/RRC inactive state for configuration of PTM reception.

In RAN2 #111-e, a number of companies proposed reusing the LTE SC-PTM mechanism for the UE in the idle/inactive state; however, as the chairman summarized as follows, a number of companies thought a significant difference was present in solutions for connected and idle/inactive states.
Chairman: A number of companies think a significant difference is present in solutions for idle and connected states. Further studies need to be conducted as to what it means ultimately.
Chairman’s observations: Many proposals to reuse (to a significant extent or 100%) LTE SC-PTM for idle/inactive NR. Some companies propose connecting to and controlling idle/inactive delivery as well, for example.

In this supplementary note, considerations on the control plane of NR MBS will be discussed.

### Discussion

In the LTE SC-PTM, configurations are provided by two messages, i.e., SIB 20 and SC-MCCH. The SIB 20 provides SC-MCCH scheduling information, and the SC-MCCH provides SC-MTCH scheduling information including the G-RNTI and the TMGI, and neighbor cell information.

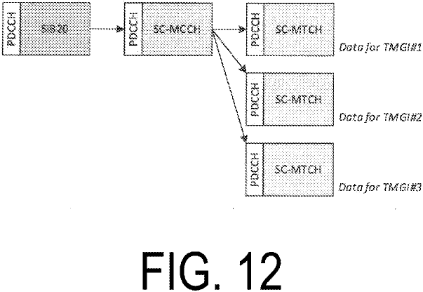

As illustrated in FIG. 12, an advantage of the LTE two-stage configuration is that the SC-MCCH scheduling is independent of the SIB 20 scheduling in terms of repetition period, duration, change period, and the like. The two-stage configuration facilitates frequent scheduling/update of the SC-MCCH, particularly for delay sensitive services and/or UEs that are delayed in participating in the session. According to the WID, one of the applications is group communication or the like, and thus it also applies to the NR MBS.

Observation 1: In LTE, the two-stage configuration using the SIB 20 and the SC-MCCH is useful for different scheduling operations for these control channels. This is also useful for the NR MBS.

Proposal 1: RAN2 should agree on use of the two-stage configuration with different messages for the NR MBS, such as the SIB 20 and the SC-MCCH for the SC-PTM.

In addition to Proposal 1, the NR MBS is assumed to support various types of use cases described in the WID. It is appreciated that the NR MBS should be appropriately designed for a variety of requirements ranging from delay sensitive applications such as mission critical applications and V2X to delay tolerant applications such as IoT, in addition to the other aspects of requirements ranging from lossless application such as software delivery to UDP type streaming such as IPTV.

Therefore, the design of the control channel should take into account flexibility and the resource efficiency of the control channel. Otherwise, for example, when one control channel includes configuration of a delay tolerant service and configuration of a delay sensitive service, the control channel needs to be frequently scheduled in order to satisfy delay requirements from the delay sensitive service. This may cause more signalling overheads.

An object A of the SA2 SI relates to enabling of general MBS services via 5GS, and specified use cases possible to receive benefits from this function include (but are not limited to) public safety, mission critical applications, V2X applications, transparent IPv4/IPv6 multicast delivery, IPTV, wireless software delivery, group communications, and IoT applications.

Observation 2: The NR MBS control channel needs to be flexible to various types of use cases and to have high resource efficiency.

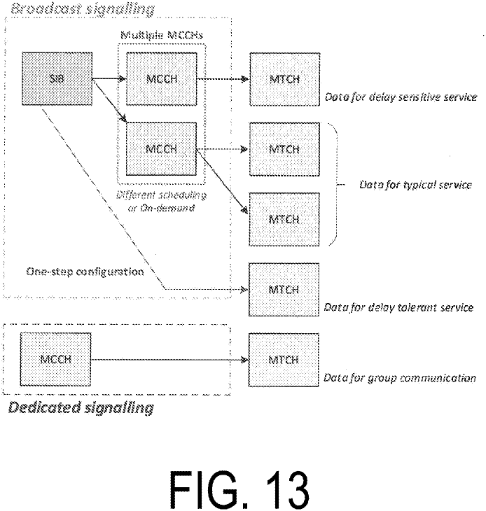

As one possibility, as illustrated in FIG. 13, whether configuration channels need to be separated in different use cases is studied. For example, one control channel frequently provides a delay sensitive service, and another control channel infrequently provides a delay tolerant service. The LTE SC-PTM is limited in that one cell includes only one SC-MCCH. However, the NR MBS may assume more use cases than LTE, and thus should be devoid of such limitation. When a plurality of SC-MCCHs are allowed within the cell, each SC-MCCH includes a scheduling configuration with a different repetition period which can be optimized for a specific service. How to identify the SC-MCCH that provides a service in which the UE takes interest needs further study.

Proposal 2: RAN2 should discuss whether the NR MBS cell supports a plurality of control channels, as is the case with a plurality of SC-MCCHs the support of which is not included in LTE.

A new paradigm of NR is support for on-demand SI transmission. This concept may be reused for the SC-MCCH in the NR MBS, i.e., on-demand SC-MCCH. For example, the SC-MCCH for delay tolerant services is provided on demand, thus enabling resource consumption for signalling to be optimized. Of course, the network includes another option for providing the SC-MCCH for delay sensitive services, periodically, i.e., not based on a demand.

Proposal 3: RAN2 should discuss an option provided when the control channel is provided on an on-demand basis, as is the case with the on-demand SC-MCCH that is not included in LTE.

As another possibility, as illustrated in FIG. 13, merging the above-described messages, i.e., one-stage configuration, may be further studied. For example, the SIB provides SC-MTCH scheduling information directly, i.e., without the SC-MCCH. This will provide optimization for delay tolerant services and/or power sensitive UE. For example, the UE may request the SIB (on demand), and the gNB may start providing the SIB and the corresponding service after requests from a plurality of UEs. These UEs do not need to monitor the SC-MCCH that is repeatedly broadcast.

Proposal 4: RAN2 should discuss options such as direct provision of the traffic channel configuration in the SIB when multicast reception with no use of the SC-MCCH (i.e., one-stage configuration) is supported.

### Dedicated Signalling-Based Configuration

Some companies proposed that the MBS configuration be provided using Dedicated Signaling only. This suggests that, although dedicated signalling has simplicity for the UEs in the RRC connected state in multicast services such as group communication, for the UEs in the idle/inactive state, the UEs invariably need to transition to the RRC connected state before receiving MBS services even if these UEs are interested only in broadcast services. This may cause unnecessary power consumption in the UEs, and may reduce future guarantees such as support of free broadcasting services in future releases. Accordingly, it is assumed that the MBS configuration using broadcast signalling is to be a baseline as in proposal 1 to proposal 4, in a manner the same as and/or similar to LTE SC-PTM.

Note that, as illustrated in FIG. 13, it is assumable that, when the control channels can be provided using the RRC reconfiguration, this shall bring about flexibility in implementation and a deployment policy of the network. For example, when being necessary for business operators or the like not broadcasting MBS control channels and not providing broadcast services, the network may only determine to provide configurations using dedicated signalling. As another example, when a target cell provides the MBS configuration using a handover command, this is beneficial for service continuity during handover.

Accordingly, in RAN2, whether the RRC reconfiguration provides MBS control channels needs to be studied.

Proposal 5: In RAN2, an option of a case in which the RRC reconfiguration provides the SC-MCCH which does not exist in LTE needs to be studied.

### Interest Indication/Counting

In LTE eMBMS, in order that the network perform appropriate determinations of MBMS data delivery including start/stop of MBMS sessions, two types of methods for collecting a UE reception/interest service are specified, i.e., MBMS interest indication (MII) and MBMS counting. MII triggered by the UE includes information related to an MBMS frequency of interest, an MBMS service of interest, an MBMS priority, and MBMS ROM (reception-dedicated mode). A counting response triggered by the network via a counting request for a specific MBMS service includes information related to an MBSFN area and an MBMS service of interest.

These methods were introduced for various purposes. MII is mainly used by the network in order to ensure that the UE can continuously receive a service that the UE is interested in while being in the connected state. In contrast, counting is used to enable the network to determine whether a sufficient number of UEs are interested in receiving a service.

Observation 3: In LTE e MBMS, two types of UE assistance information are introduced for different purposes. In other words, MBMS interest indication is introduced for scheduling of NB, and MBMS counting is introduced for session control of MCE.

In a case of NR MBS, multicast services for use cases of group communication and the like are expected, and the network has full knowledge related to the MBS service that the UE in the connected state is receiving/interested in, and thus assistance information from the UE is not necessary, such as the network’s determination regarding PTP/PTM delivery. However, our understanding is that this does not apply to broadcast services and the UEs in the idle/inactive state. In a case of broadcast services in particular, NR MBS still has the same problem as that solved by MII and counting in LTE eMBMS, i.e., observation 3. Thus, in RAN2, whether the assistance information, such as MII and counting, is useful for NR MBS needs to be studied.

As described in WID, since ROM and SFN are not supported, in Rel-17, it is noted that MBMS ROM information of MII and information related to the MBSFN area of the counting response are not necessary.

Proposal 6: In RAN2, for example, introduction of the UE assistance information of NR MBS, such as MBMS interest indication and/or MBMS counting, needs to be agreed upon.

When proposal 6 can be agreed upon, it is worthwhile to carry out a study on extended functions, in addition to LTE eMBMS. In LTE eMBMS, even when most of the UEs receive broadcast services in the RRC idle state, information of neither MII nor counting can be collected from the UEs in the idle state. To our understanding, this is one of the problems that LTE eMBMS has from the viewpoint of session control and resource efficiency.

In NR MBS, the same problem may be present in the UEs in the idle/inactive state. For example, the network cannot know whether the UEs in the idle/inactive state are receiving/interested in broadcast services. Thus, even if no UE receiving services is present, PTM transmission may be continued. If the gNB recognizes interest of the UEs in the idle/inactive state, such unnecessary PTM can be avoided. Conversely, if PTM stops while UEs in the idle/inactive state receiving services are still present, a plurality of UEs may simultaneously request connection.

Accordingly, it is worthwhile to carry out a study as to whether to introduce a mechanism for collecting the UE assistance information, specifically MBMS counting, from the UE in the idle/inactive state. Needless to say, it is desirable that the UEs in the idle/inactive state be capable of reporting information without transitioning to RRC connected. For example, PRACH resource partitioning associated with the MBS service may be achieved when being introduced to such a report.

Proposal 7: In RAN2, whether the UE assistance information such as MBMS counting is also collected from the UE in the idle/inactive state needs to be studied.

1. A communication control method used in a mobile communication system for providing a multicast and broadcast service (MBS) from a first base station to a first user equipment, the communication control method comprising:
collecting, by the first base station and from at least one second base station within a predetermined range from the first base station, MBS interest information received by the at least one second base station from a second user equipment; and
controlling, by the first base station, MBS transmission of the first base station, based on the MBS interest information collected.

2. The communication control method according to claim 1, wherein
the collecting comprises
receiving, by the at least one second base station, the MBS interest information from the second user equipment,
transmitting, by the first base station, a transmission request for the MBS interest information to the at least one second base station, and
transmitting, by the at least one second base station, the MBS interest information to the first base station in response to reception of the transmission request from the first base station.

3. The communication control method according to claim 1, wherein
the collecting comprises
receiving, by the at least one second base station, the MBS interest information from the second user equipment in a Radio Resource Control (RRC) connected state,
transitioning, by the at least one second base station, the second user equipment to an RRC idle state or an RRC inactive state, and
transmitting, by the at least one second base station and to the first base station, the MBS interest information received by the at least one second base station from the second user equipment.

4. The communication control method according to claim 1, wherein
the controlling the MBS transmission of the first base station comprises
determining whether the first base station is to establish MBS connection with a core network apparatus or whether to transmit MBS data received by the first base station from the core network apparatus through PTP or PTM, based on the MBS interest information collected.

5. A communication control method used in a mobile communication system for providing a multicast and broadcast service (MBS) from a base station to a user equipment, the communication control method comprising:
notifying, by the user equipment in a Radio Resource Control (RRC) idle state or an RRC inactive state, a base station of MBS interest information at time of a random access procedure to the base station; and
after notification of the MBS interest information, terminating, by the user equipment, the random access procedure without the user equipment transitioning to an RRC connected state.

6. The communication control method according to claim 5, further comprising
receiving, by the user equipment and from the base station, a request message for requesting transmission of the MBS interest information, wherein
the notifying the base station of the MBS interest information comprises notifying, by the user equipment, the base station of the MBS interest information at the time of the random access procedure in response to reception of the request message.

7. The communication control method according to claim 5, wherein
the random access procedure comprises preamble transmission of transmitting a random access preamble from the user equipment to the base station, and
the notifying the base station of the MBS interest information comprises notifying the base station of the MBS interest information through the preamble transmission.

8. The communication control method according to claim 5, wherein
the random access procedure comprises predetermined message transmission of transmitting a predetermined message from the user equipment to the base station in response to reception of a random access response from the base station by the user equipment, and
the notifying the base station of the MBS interest information comprises notifying the base station of the MBS interest information through the predetermined message transmission.

9. The communication control method according to claim 8, wherein
the random access procedure comprises preamble transmission of transmitting a random access preamble from the user equipment to the base station, and
the user equipment notifies, through the preamble transmission, the base station that the user equipment is to perform notification of the MBS interest information through the predetermined message transmission.
